(19) United States
(12) Patent Application Publication
(10) Pub. No.: US 2006/0084776 A1
(43) Pub. Date: Apr. 20, 2006

(54) Crystallization-stable MDI allophanates by a two-stage process

(75) Inventors: Joachim Simon, Dusseldorf (DE); Gerhard Ruttmann, Burscheid (DE); Burkhard Kohler, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/251,146

(22) Filed: Oct. 14, 2005

(30) Foreign Application Priority Data
Oct. 20, 2004 (DE) 102004051026.1

(51) Int. Cl. C08G 18/00

(52) U.S. Cl. 528/44

(57) ABSTRACT

The present invention relates to new diphenylmethane diisocyanate (i.e. MDI) allophanates and to a process for their preparation. These new MDI allophanates are prepared by a two-stage process, which in spite of a relatively high degree of oligomerization are distinguished by crystallization stability.

### CROSS-REFERENCE TO RELATED PATENT APPLICATION

The present patent application claims the right of priority under 35 U.S.C. §119(a)-(d) of German Patent Application No. 10 2004 051 026, filed Oct. 20, 2005.

### BACKGROUND OF THE INVENTION

The present invention relates to new MDI allophanates, and to two-stage process for the preparation of these new MDI allophanates. The MDI allophanates of the present invention are distinguished by a relatively high degree of oligomerization and by crystallization stability.

As used herein, MDI refers to mixtures of the 2,2′-, 2,4′- and 4,4′-isomers of diisocyanatodiphenylmethane, in which it is possible for the 2,2′-MDI isomer to be present in amounts up to 2% by weight.

Both the 2,4′-MDI isomer and also the 4,4′-MDI isomer of MDI are crystalline at room temperature. This crystalline state is problematic for practical applications, since frequently liquid, aromatic isocyanates based on MDI are required.

Some possibilities for the preparation of liquid MDI derivatives include the partial reaction of NCO groups with diols, accompanied by urethanization (see U.S. Pat. No. 3,644,457), the carbodiimidization (i.e. reaction with carbodiimidazation catalysts, as described in, for example, U.S. Pat. No. 4,154,752) or the allophanatization (i.e. reaction with monoalcohols as described in, for example, EP-A 1 371 637).

Sufficient crystallization stability in such products is customarily attained when the isocyanate content of the modified products lies between 19% and 28% NCO by weight. At NCO contents in this range, and in the case of a one-stage reaction regime, the amount of species of relatively high molecular mass, with a degree of oligomerization of 4 or more, in the reaction mixture is relatively low. At NCO contents above 28% by weight, solidification by crystallization often ensues in such products, while at contents below 19% by weight the viscosity becomes too high.

GB 1369334 describes the derivatization of MDI by the formation of urethane, with a two-stage procedure being adopted. The reaction of the diol takes place first only with a portion of the MDI, in order to promote the formation of pre-extended (advanced) oligourethanes, which are then blended with free MDI in the second stage. Products of this kind contain no allophanate groups.

The allophanatization reaction, for example, as described in EP-A 1 371 637, yields MDI allophanates which are crystallization-stable, but have only a low fraction of relatively high molecular mass species with a degree of oligomerization of 4 or more. These MDI allophanates are therefore capable of improvement in terms of their mechanical properties.

### SUMMARY OF THE INVENTION

It was an object of the invention to provide crystallization-stable MDI allophanates which are notable for a relatively high fraction of relatively high molecular mass species, and which therefore, exhibit improved mechanical properties, and particularly, with regard to the tear propagation resistance of coatings and paints produced from these MDI allophanates.

It has now been found that this object can be achieved by means of specific MDI allophanates in which the decrease in the frequency of the species with increasing degree of oligomerization obeys (or follows) a specified geometric sequence, with the geometric sequence being such that the species n+1 makes up at least 50% of the amount of species n. Accordingly, the invention provides polyisocyanates based on MDI and which contain allophanate groups, in which at least the frequency of the first four oligomeric species with increasing degree of oligomerization follows a geometric series, with the respective n+1 species making up at least 50 mol % of the amount of the preceding species n of low molecular mass. In this context, the degree of polymerization 1 comprises the allophanate which results by reaction of one mole of MDI with the monourethane formed from monoalcohol and MDI. The species n+1 contains at least one further molecule of MDI and no monoalcohol, or one further molecule of monoalcohol.

In accordance with the present invention, it is preferred that at least the first 6 allophanate species, and more preferably at least the first 8 allophanate species, follow this rule.

The MDI-based allophanates of the invention additionally have the advantage, owing to the similar viscosity, of better miscibility with polyols. This better miscibility with polyols improves the processing properties, and leads to more homogeneous paints and coatings.

Typically, the species of the allophanates have degrees of oligomerization of varying from 1 to 100, and preferably of 1 to 20.

The present invention also provides a process for preparing the polyisocyanates of the invention containing allophanate groups. This process comprises

(1) reacting
A) one or more monohydroxy compounds,
with
B) diphenylmethane diisocyanate (i.e. MDI),
without a catalyst, in an NCO/OH ratio of 2:1 to 3:1, and at a temperature of 20° C. to 120° C. until the theoretical isocyanate content of complete urethanization has been reached, and subsequently,
   (2) adding
C) an additional 3 to 5 equivalents of diphenylmethane diisocyanate (MDI), based on the amount of monohydroxy compound originally used in A),
together with
D) one or more allophanate catalysts,

and continuing the reaction at temperatures of 20° C. to 120° C. until the theoretical isocyanate content of complete allophanatization has been reached.

The theoretical isocyanate content after urethanization is calculated based on the assumption that each equivalent of the monohydroxy compound reacts with one isocyanate group to form one urethane group. The theoretical isocyanate content after allophanatization is calculated based on the assumption that each urethane group formed in the first step reacts with one isocyanate group to form an allophanate group.

Preferably, the urethanization and the allophanatization are carried out at temperatures of 60° C. to 100° C.

Following the allophanatization, it is preferred to add 25 to 500 ppm of an acid chloride, based on the total amount of the allophanate formed, for the purpose of stabilization. Any other known catalyst stopper can also be used. A preferred acid chloride is benzoyl chloride.

In the first stage of the process, preferably the monoalcohol is metered in to the diphenylmethane diisocyanate (MDI), which forms the initial charge.

As used herein, MDI in accordance with the purposes of the present invention means a mixture or mixtures of the 2,2′-isomer, 2,4′-isomer and/or 4,4′-isomer of diisocyanatodiphenylmethane, in which the 2,2′-isomer may be present in amounts up to 2% by weight. The amount of 4,4′-isomer is preferably 50% to 100% by weight, more preferably 85% to 100% by weight, and most preferably 95% to 100% by weight. In one particularly preferred embodiment, the MDI used is pure 4,4′-MDI.

The MDI used herein contains preferably less than 15% by weight of polymeric fractions.

As monohydroxy compounds it is preferred to use aliphatic, cycloaliphatic or aromatic alcohols having up to 36 C (carbon) atoms. Apart from the OH group, these alcohols may optionally, also be substituted, and/or may contain heteroatoms. Preferred monoalcohols are aliphatic, primary alcohols and have 4 to 12 carbon atoms. Examples of such monoalcohols include compounds such as n-butanol, n-hexanol, 2-ethylhexanol, n-octanol or the ether-bridge alcohols methyl glycol, butyl glycol, diethylene glycol monomethyl ether, triethylene glycol monomethyl ether and methoxypropanol.

Suitable allophanate catalysts include, preferably, zinc salts, cobalt salts and/or lead salts of saturated or unsaturated C₈-C₂₂ carboxylic acids, or zinc chelates or cobalt chelates with acetylacetone.

Examples of suitable acid chlorides used to stabilize the allophanates include, but are not limited to, benzoyl chloride, phthaloyl chloride, isophthaloyl chloride or terephthaloyl chloride.

The MDI allophanates of the present invention are suitable to be used as the isocyanate component in the preparation of thermoplastic, elastomeric or crosslinked polyurethanes. In addition, these MDI allophanates are notable for ease of preparation, effective crystallization stability and good mechanical properties of the coatings and plastics produced from them, particularly with regard to their tear propagation resistance. The polyurethanes resulting from the MDI allophanates of the invention are suitable, for example, for coatings, thermoplastic elastomers, adhesives and foams.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Unless indicated otherwise, all percentages are to be understood as being percent by weight.

The oligomer distribution was determined by GPC using THF as eluent. For the purposes of the experiments below, the relative amount of the individual oligomers or allophanate species, determined by the measured area percentages, has been stated, the amount of MDI allophanate with the degree of polymerization 1 being set at 1, and the amount of the respectively subsequent species n+1 being based in each case on the amount of the next smaller species n. None of these numbers should be below 0.5, i.e. the frequency of the species with increasing degree of oligomerization obeys a geometric order, and the species n+1 ought in each case to make up at least 50% of the amount of species n.

The viscosities were determined by means of cone-plate viscometry at 23° C.

### Example 1

2.5 equivalents of 4,4′-diisocyanatodiphenylmethane were introduced at 80° C., and over the course of 1 h, one equivalent of n-butanol was added. Stirring was continued at this temperature until an isocyanate content of 16.3% was reached, and then the allophanatization was commenced by adding 4.5 equivalents of 4,4′-diisocyanatodiphenylmethane and 100 ppm of zinc octoate (as a 50% strength solution in methoxypropyl acetate). When the isocyanate content of 22.0% was been reached, 100 ppm of benzoyl chloride were added and the reaction mixture was cooled.

The distribution of the first four allophanate species follows the following series: 1/0.81/0.63/0.58

The viscosity at 23° C. was 657 mPas.

### Example 2

2.5 equivalents of 4,4′-diisocyanatodiphenylmethane were introduced at 80° C., and over the course of 1 h, one equivalent of n-butanol was added. Stirring was continued at this temperature until an isocyanate content of 16.3% was reached, and then the allophanatization was commenced by adding 4.5 equivalents of a mixture of 85% by wt. of 4,4′-diisocyanatodiphenylmethane and 15% by wt. of 2,4′-diisocyanatodiphenylmethane and 100 ppm of zinc octoate (as a 50% strength solution in methoxypropyl acetate). When the isocyanate content of 22.0% was reached, 100 ppm of benzoyl chloride were added and the reaction mixture was cooled.

The distribution of the first four allophanate species followed the following series: 1/0.82/0.60/0.53

### Comparative Example

At 80° C., 7 equivalents of 4,4′-diisocyanatodiphenylmethane were introduced and a solution of 100 ppm of zinc octoate in one equivalent of n-butanol was added over the course of 1 h. Stirring was continued at this temperature until the isocyanate content of 22% was reached. Finally, the product was stabilized by adding 100 ppm of benzoyl chloride.

The distribution of the first four allophanate species followed the following series: 1/0.5/0.34/0.52

The viscosity at 23° C. was 450 mPas.

Performance Testing:

In order to investigate the tear propagation resistance, measured in accordance with DIN S35/5, the product from Example 1 and the product from the Comparative example were each admixed at an NCO/OH ratio of 1.05 with a polyol having an OH content of 5.4%, consisting of 75% castor oil and 25% of a linear polyester having a molar mass Mₙ of 2620 g/mol, with a viscosity of 950 mPas, formed from adipic acid and diethylene glycol, and the mixture was reacted at room temperature and without catalyst. The paint films thus obtained were subjected after 3 days to an investigation of their tear propagation resistance in accordance with DIN S35/5. In this investigation, it was found that polyurethanes based on the allophanate from Example 1 have a much higher strength, at 39.4 MPa, than those polyurethanes based on the allophanate of the Comparative example, at 33.0 MPa.

The inventive MDI allophanate from Example 1 is crystallization-stable at −10° C. for 23 days, whereas the MDI allophanate of the Comparative example begins to crystallize out after just 7 days, which is manifested by marked clouding of the sample and subsequent precipitation of solid.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyisocyanate based on diphenylmethane diisocyanate and containing allophanate groups, in which at least the frequency of the first four oligomeric species with increasing degree of oligomerization follows a geometric series and the respective n+1 species makes up at least 50 mol % of the amount of the preceding species n of lower molecular mass.

2. The polyisocyanate containing allophanate groups of claim 1, wherein at least the first 6 allophanate species formed meet the required rule.

3. A process for preparing the polyisocyanates containing allophanate groups of claim 1, comprising
(1) reacting
A) one or more monohydroxy compounds,
with
B) diphenylmethane diisocyanate,
without a catalyst, in an NCO:OH ratio of 2:1 to 3:1, and at a temperature of 20 to 120° C. until the theoretical isocyanate content of complete urethanization has been reached,
and subsequently
(2) adding
C) an additional 3 to 5 equivalents of diphenylmethane diisocyanate, based on the amount of monohydroxy compound originally used in A),
together with
D) one or more allophanate catalyst,
and continuing the reaction at temperatures of 20 to 120° C. until the theoretical isocyanate content of complete allophanatization has been reached.

4. The process for preparing polyisocyanates containing allophanate groups of claim 3, in which the temperature during the urethanization and the allophanatization is 60 to 100° C.

5. The process for preparing polyisocyanates containing allophanate groups of claim 3, additionally comprising adding 25 to 500 ppm of an acid chloride, based on the total amount of the allophanate formed, for the purpose of stabilization, after the allophanatization is complete.

6. The process for preparing polyisocyanates containing allophanate groups of claim 3, wherein A) said one or more monohydroxy compounds comprise primary, aliphatic monoalcohols having 4 to 12 carbon atoms.

7. The process for preparing polyisocyanates containing allophanate groups of claim 3, wherein D) said one or more allophanate catalysts comprises one or more zinc salts, one or more cobalt salts, or one or more lead salts of optionally unsaturated C8-C22 carboxylic acids, or zinc acetylacetonates, or cobalt acetylacetonates.

8. In a process for the production of thermoplastic, elastomeric or crosslinked polyurethanes, comprising reacting a polyisocyanate component with an isocyante-reactive component, the improvement wherein said polyisocyanate component comprises the polyisocyanate containing allophanate groups of claim 1.
